(19) United States
(12) Patent Application Publication
(10) Pub. No.: US 2016/0295181 A1
(43) Pub. Date: Oct. 6, 2016

(54) DLP PICO-PROJECTOR

(71) Applicant: IVIEW LIMITED, Hong Kong (CN)

(72) Inventors: Zhiqiang GAO, Hong Kong (CN); Yuan ZHAO, Hong Kong (CN); Steve YEUNG, Hong Kong (CN); Qingyun LIN, Hong Kong (CN)

(21) Appl. No.: 15/037,922

(22) PCT Filed: Nov. 7, 2014
(86) PCT No.: PCT/CN2014/090574

§ 371 Date: May 19, 2016

(30) Foreign Application Priority Data
Aug. 15, 2014 (CN) 201410404599

(51) Int. Cl. H04N 9/31; G02B 27/30; G02B 17/08; G02B 27/09; G02B 17/00; G02B 27/14; G02B 1/11

(52) U.S. Cl. CPC H04N 9/3173; H04N 9/3164; G02B 27/141; G02B 27/30; G02B 1/11; H04N 9/3152; G02B 27/0961; H04N 9/3158; G02B 17/008; G02B 17/0852

(57) ABSTRACT

The invention provides a DLP pico-projector, including: a light supply device, the light supply device including: a first LED light source including a first LED luminous chip and a second LED luminous chip which are packaged together, a first collimation lens group corresponding to the first LED light source, a third LED luminous chip, a second collimation lens group corresponding to the third LED luminous chip, and a spectroscope; a lighting optical system, the lighting optical system including: a beam shaping component, a wedge-shaped optical component, and a beam guiding component; the wedge-shaped optical component including a third working face and a fourth working face which are unparallel to one another, the third working face being coated with a dichroic film, and the fourth working face being coated with a reflective film or a dichroic film; a DLP light modulator; and a projection lens group. The design compacts the deployment of the projector, simplifies the optical elements, reduces the optical loss, and reduces the size and weight of the projector, all of which is favorable for the projector to carry and be applied in handheld electronic devices.

### FIELD OF THE INVENTION

The invention relates to the field of digital projection display, and more particularly to a DLP pico-projector.

### BACKGROUND OF THE INVENTION

With the development of science and semiconductor technology, more and more portable electronic devices are designed and manufactured. With the diversification of the functions of the portable electronic devices, the human-machine interface displays are increasingly miniature, and have large screen and high resolution. In recent years, pico-projectors have been developed quickly, and products such as DLP, LCOS, portable hand-held micro-projectors (PICO), or projector modules built in handheld mobile devices such as mobile phones are invented. DLP projectors are superior to conventional LCD and LCOS projectors in lumen brightness, video image displaying and contrast, so they are popular among consumers.

To apply conventional DLP pico-projectors to handheld electronic devices, first of all, a high light output must be ensured, in addition, the projection light path should be concise and efficient, so that the projectors feature small size, light weight, and low optical loss, which is favorable for the projectors to be installed in handheld electronic devices.

A typical DLP pico-projector is shown in FIG. 1, of which the light supply device includes a spectroscope group 500 (including a first spectroscope 501 and a second spectroscope 502), and three-colored LED lights are incident to subsequent optical devices in parallel. However, there is an included angle between the first spectroscope 501 and the second spectroscope 502, the design involves complex manufacture process and occupies much space, the optical path is not compact, thus increasing the size of the projector. In addition, the RGB lights experience the two times' transmission of the first spectroscope 501 and the second spectroscope 502 (two dichroic filters), which causes lots of light loss. The two design defects fail to satisfy the requirements of the handheld electronic devices for projectors having small size, light weight, and low optical loss.

The information disclosed in the background of the invention aims to facilitate the understanding of the general background of the invention, which should not be regarded directly or indirectly as admission or suggestion that the invention has been a well-known technology to one of ordinary skill in the art.

### SUMMARY OF THE INVENTION

One objective of the invention is to provide a DLP pico-projector that has a simple and reasonable structure. The DLP pico-projector employs a wedge-shaped optical component to substitute for a reflective mirror used in the lighting optical system of conventional DLP pico-projectors, so that conventional two dichroic filters which are in a fan-shaped arrangement are replaced by a single spectroscope, thus compacting the deployment of the projector, simplifying the optical elements, reducing the optical loss, reducing the size and weight of the projector, all of which is favorable for the projector to carry and be applied in handheld electronic devices.

To achieve the above objective, the invention provides a DLP pico-projector, characterized by comprising: a light supply device, the light supply device comprising: a first LED light source comprising a first LED luminous chip and a second LED luminous chip which are packaged together, a first collimation lens group corresponding to the first LED light source, a third LED luminous chip, a second collimation lens group corresponding to the third LED luminous chip, and a spectroscope comprising a first working face and a second working face; the first working face being coated with a dichroic film and the second working film being coated with an anti-reflection film, or the first working face being coated with an anti-reflection film and the second working film being coated with a dichroic film; a lighting optical system, the lighting optical system comprising: a beam shaping component, a wedge-shaped optical component, and a beam guiding component; the wedge-shaped optical component comprising a third working face and a fourth working face which are unparallel to one another, the third working face being coated with a dichroic film, and the fourth working face being coated with a reflective film or a dichroic film; a DLP light modulator; and a projection lens group.

In a class of this embodiment, the first LED luminous chip, the second LED luminous chip, and the third LED luminous chip emit a first beam, a second beam, and a third beam, respectively; the first beam or the second beam is coincident with a central optical axis of the first collimation lens group, and the third beam is coincident with a central optical axis of the second collimation lens group.

In a class of this embodiment, the beam shaping component comprises a fly-eye lens or an optical wand and a first relay lens.

In a class of this embodiment, the beam shaping component is disposed between the light supply device and the wedge-shaped optical component, or between the wedge-shaped optical component and the beam guiding component.

In a class of this embodiment, a dihedral angle formed by the third working face and the fourth working face is greater than 1 degree and smaller than 45 degrees.

In a class of this embodiment, an included angle formed by the wedge-shaped optical component and a central optical axle of the beam shaping component is greater than 15 degrees and smaller than 80 degrees.

In a class of this embodiment, the beam guiding component comprises a relay lens and a right-angle prism group.

In a class of this embodiment, the beam guiding component comprises a freeform lens and a right-angle prism

In a class of this embodiment, the beam guiding component comprises a field lens and a reflection mirror.

Advantages of the invention are summarized as follows. The DLP pico-projector employs a wedge-shaped optical component to substitute for a reflective mirror used in the lighting optical system of conventional DLP pico-projectors, so that conventional two dichroic filters which are in a fan-shaped arrangement are replaced by a single spectroscope, thus compacting the deployment of the projector, simplifying the optical elements, reducing the optical loss, reducing the size and weight of the projector, all of which is favorable for the projector to carry and be applied in handheld electronic devices.

### BRIEF DESCRIPTION OF THE DRAWINGS

FIG. 1 is a schematic diagram of a DLP pico-projector in the prior art;

FIG. 2 is a schematic diagram of a DLP pico-projector in Example 1 of the invention;

FIG. 2A is a schematic diagram of a beam guiding component of a DLP pico-projector in Example 1 of the invention;

FIG. 2B is another schematic diagram of a beam guiding component of a DLP pico-projector in Example 1 of the invention;

FIG. 2C is a schematic diagram of a beam shaping component of a DLP pico-projector in Example 1 of the invention;

FIG. 3 is a schematic diagram of a DLP pico-projector in Example 2 of the invention;

FIG. 4 is a schematic diagram of a DLP pico-projector in Example 3 of the invention; and

FIG. 5 is a schematic diagram of a DLP pico-projector in Example 4 of the invention.

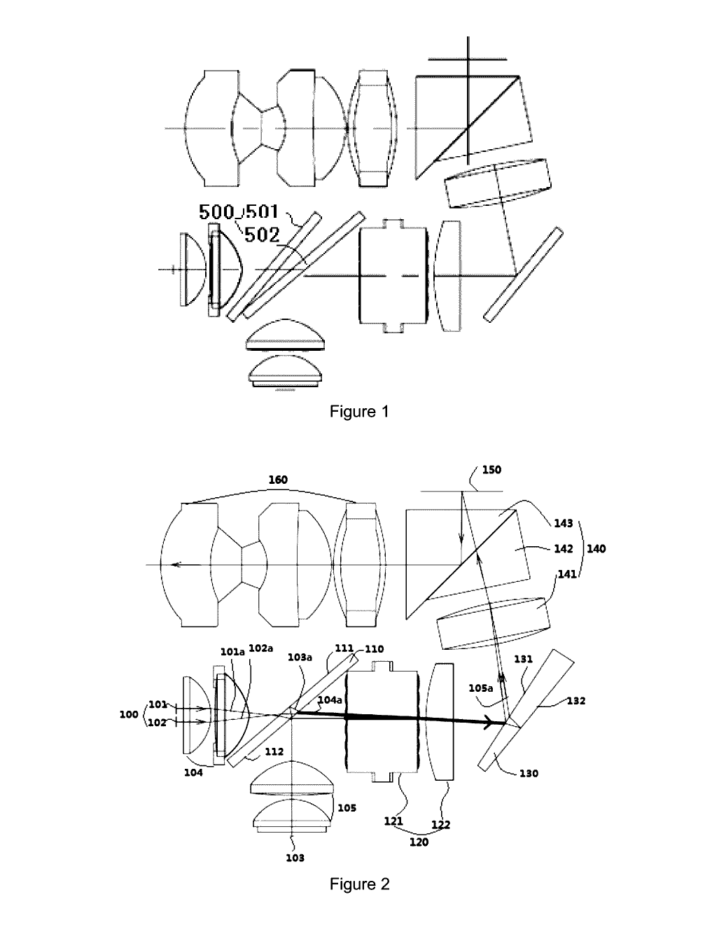

### DETAILED DESCRIPTION OF THE EMBODIMENTS

For clear understanding of the objectives, features and advantages of the invention, detailed description will be given below in conjunction with accompanying drawings and specific embodiments. It should be noted that the examples are only meant to explain the invention, and not to limit the scope of the invention.

Unless otherwise indicated, terms “comprise” or “comprising” in the specifications and claims of the invention should be considered as including stated elements or components, and not excluding other elements or components.

### EXAMPLE 1

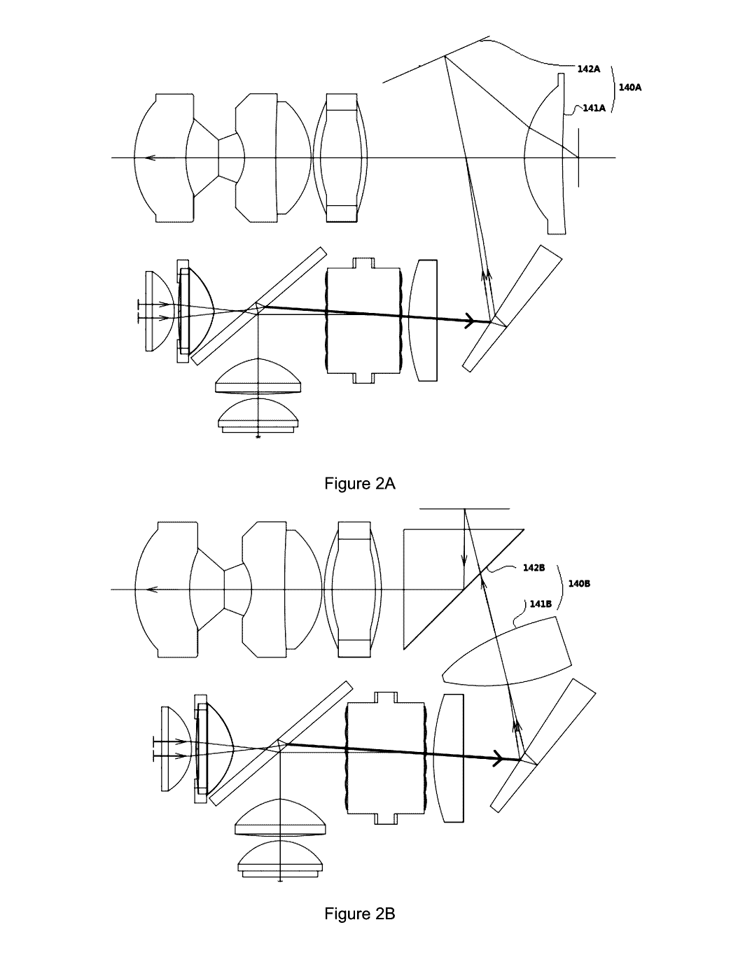

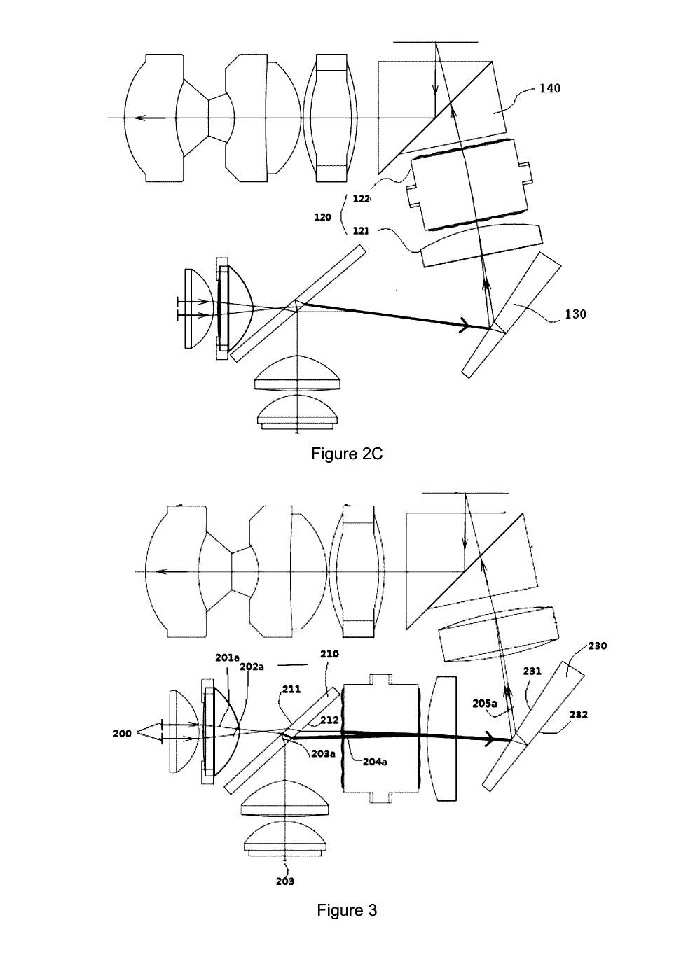

As shown in FIG. 2, a DLP pico-projector comprises along the light path: a light supply device, a lighting optical system, a DLP light modulator, and a projection lens group.

The light supply device comprises a first LED light source 100 comprising a first LED luminous chip 101 and a second LED luminous chip 102 which are packaged together, a first collimation lens group 104 corresponding to the first LED light source 100, a third LED luminous chip 103, a second collimation lens group 105 corresponding to the third LED luminous chip, and a spectroscope 110.

The first LED luminous chip 101, the second LED luminous chip 102, and the third LED luminous chip 103 emit a first light beam 101a, a second light beam 102a, and a third light beam 103a, respectively. The first light beam 101a, second light beam 102a, and third light beam 103a have different colors, and can be combined to yield white light. For example, the first light beam 101a, the second light beam 102a, and the third light beam 103a can be red, blue, and green (RBG), or cyan, yellow, and magenta (CYM). The first light beam 101a or the second light beam 102a is coincident with the central optical axis of the first collimation lens group 104, and the third light beam 103a is coincident with the central optical axis of the second collimation lens group 105.

The spectroscope 110 is in an optical connection to the first collimation lens group 104 and the second collimation lens group 105, to treat the LED RGB lights (101a, 102a, and 103a) collimated by the first collimation lens group 104 and the second collimation lens group 105, respectively. The spectroscope 110 comprises a first working face 111 and a second working face 112; the first working face 111 is coated with a dichroic film, which allows the first light beam 101a and the second light beam 102a to transmit and reflects the third light beam 103a; and the second working film 112 is coated with an anti-reflection film. Under the action of the dichroic film on the first working face 111, the second light beam 102a and the third light beam 103a are combined to yield a fourth light beam 104a, which is incident to subsequent optical components along with the first light beam 101a.

The lighting optical system comprising: a beam shaping component 120, a wedge-shaped optical component 130, and a beam guiding component 140. The beam shaping component 120 comprises a fly-eye lens 121 or an optical wand and a first relay lens 122, operates to receive the first light beam 101a and the fourth light beam 104a from the spectroscope 110 and guide the two light beams to subsequent optical components. The beam shaping component 120 is disposed between the light supply device and the wedge-shaped optical component, or between the wedge-shaped optical component 130 and the beam guiding component 140 (as shown in 2C).

The wedge-shaped optical component 130 comprises a third working face 131 and a fourth working face 132 which are unparallel to one another, and a dihedral angle formed by the third working face and the fourth working face is greater than 1 degree and smaller than 45 degrees. The third working face 131 is coated with a dichroic film, and the fourth working face 132 is coated with a reflective film or a dichroic film. When the third working face 131 is coated with the dichroic film to reflect the first light beam 101a, the fourth working face 132 is a reflective film or is coated with a dichroic film to reflect the fourth light beam 104a. Vice versa, when the third working face 131 is coated with the dichroic film to reflect the fourth light beam 104a, the fourth working face 132 is a reflective film or is coated with a dichroic film to reflect the first light beam 101a. The first light beam 101a and the fourth light beam 104a emitted from the beam shaping component 120 are treated by the third working face 131 and the fourth working face 132 of the wedge-shaped optical component 130, to combine to yield a white light beam 105a.

The included angle formed by the wedge-shaped optical component 130 and a central optical axle of the beam shaping component is greater than 15 degrees and smaller than 80 degrees, so that the incident angle of the light beam from the beam shaping component 120 on the reflection surface (131 or 132) is greater than 30 degrees and smaller than 60 degrees. Preferably, the incident angle of the light beam from the beam shaping component 120 on the reflection surface (131 or 132) is 45 degrees.

The beam guiding component 140 can be optical component group comprises a relay lens 141 and a right-angle prism group (142 and 143), or comprises a freeform lens 141B and a right-angle prism 142B (as shown in FIG. 2B, or comprises a field lens 141A and a reflection mirror 142A (as shown in FIG. 2A).

The white light beam 105a is transmitted via the beam guiding component 140 to the DLP light modulator. When the DMD chip 150 is in an open state, the illuminating beam is converted into an image beam and totally reflected on the hypotenuse of the right-angle prism 143, and then is projected along the horizontal direction on the projection lens group 160.

### EXAMPLE 2

FIG. 3 is a schematic diagram of a DLP pico-projector in this example 2. As shown in FIG. 3, the projection modules are the same as that in Example 1 except that, the light supply device in this example allows the first light beam 201a and the third light beam 203a to combine, and the wedge-shaped optical component is adjusted accordingly.

Specifically, adjust the angle of the spectroscope 210 or the position of the LED light source 200 or the position of the third LED luminous chip 203, under the action of the dichroic film on the first working face 211 of the spectroscope 210, the first light beam 201a and the third light beam 203a are combined to yield a fourth light beam 204a, which is incident to subsequent optical components along with the second light beam 202a.

The lighting optical system is also adjusted accordingly. The wedge-shaped optical component 230 comprises a third working face 231 and a fourth working face 232. When the third working face 231 is coated with the dichroic film to reflect the second light beam 202a, the fourth working face 232 is a reflective film or is coated with a dichroic film to reflect the fourth light beam 204a. Vice versa, when the third working face 231 is coated with the dichroic film to reflect the fourth light beam 204a, the fourth working face 232 is a reflective film or is coated with a dichroic film to reflect the second light beam 202a. The second light beam 202a and the fourth light beam 204a emitted from the beam shaping component 120 and the first relay lens 121 are treated the wedge-shaped optical component 230, to combine to yield a white light beam 205a.

### EXAMPLE 3

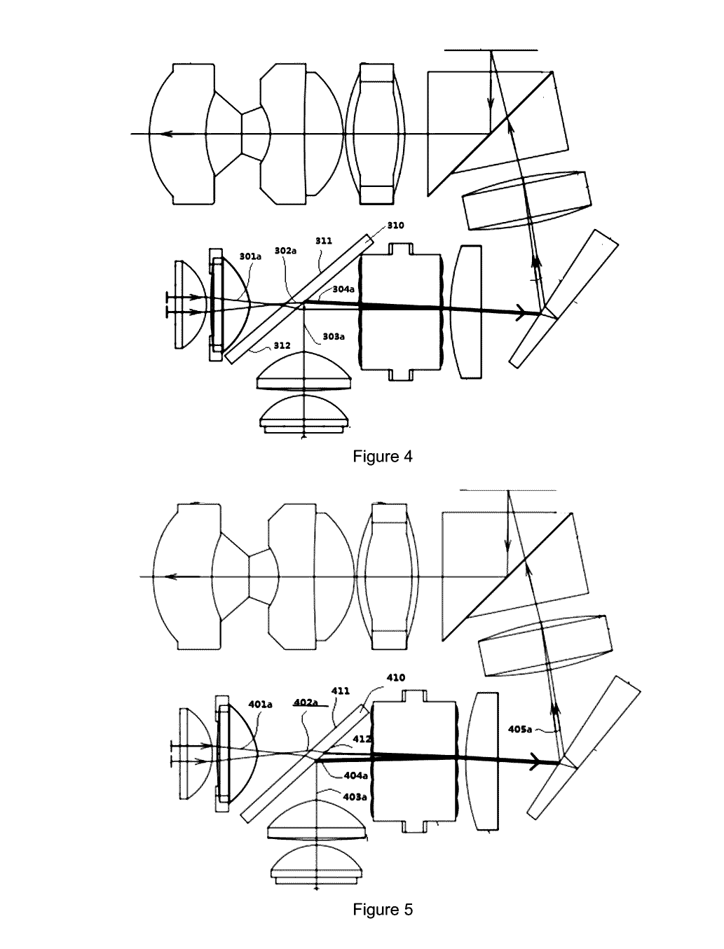

FIG. 4 is a schematic diagram of a DLP pico-projector in this example 3. As shown in FIG. 4, the projection modules are the same as that in Example 1 except that, the first working face 311 of the spectroscope 310 is coated with an anti-reflection film, while the second working face 312 is coated with a dichroic film, so that the second light beam 302a and the third light beam 303a are combined on the second working face 312. Specifically, the spectroscope 310 comprises a first working face 311 and a second working face 312. The first working face 311 is coated with an anti-reflection film, while the second working face 312 is coated with a dichroic film. The third light beam 303a is reflected via the dichroic film on the second working face 312 of the spectroscope and is combined with the second light beam 302a to yield a fourth light beam 304a, and then is incident to subsequent optical components along with the first light beam 301a.

### EXAMPLE 4

FIG. 5 is a schematic diagram of a DLP pico-projector in this example 4. As shown in FIG. 5, the projection modules are the same as that in Example 2 except that, the first working face 411 of the spectroscope 410 is coated with an anti-reflection film, while the second working face 412 is coated with a dichroic film, so as to combine lights. Specifically, the spectroscope 410 comprises a first working face 411 and a second working face 412. The first working face 411 is coated with an anti-reflection film, while the second working face 412 is coated with a dichroic film. Adjust the angle of the spectroscope 410 or the angle of the LED light source, the third light beam 403a is reflected via the dichroic film on the first working face 411 of the spectroscope and is combined with the first light beam 401a to yield a fourth light beam 404a, which is incident to subsequent optical components along with the second light beam 402a.

It should be noted that, although the first LED luminous chip and the second LED luminous chip are packaged together to yield the first LED light source, and the third LED luminous chip acts as the second LED light source, it is not definite. Any at least two of the first LED luminous chip, the second LED luminous chip, and the third LED luminous chip can be packaged to form the first LED light source. Likewise, the color order of the first beam, the second beam, and the third beam are not definite. For example, when the three light beams are RGB, the first, second and third light beams are red, blue, and green, respectively, or the first, second and third light beams are blue, red, and green, respectively.

In summary, the DLP pico-projector employs a wedge-shaped optical component to substitute for a reflective mirror used in the lighting optical system of conventional DLP pico-projectors, so that conventional two dichroic filters which are in a fan-shaped arrangement are replaced by a single spectroscope, thus compacting the deployment of the projector, simplifying the optical elements, reducing the optical loss, reducing the size and weight of the projector, all of which is favorable for the projector to carry and be applied in handheld electronic devices.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A DLP pico-projector, comprising:
a light supply device, the light supply device comprising: a first LED light source comprising a first LED luminous chip and a second LED luminous chip which are packaged together, a first collimation lens group corresponding to the first LED light source, a third LED luminous chip, a second collimation lens group corresponding to the third LED luminous chip, and a spectroscope comprising a first working face and a second working face; the first working face being coated with a dichroic film and the second working film being coated with an anti-reflection film, or the first working face being coated with an anti-reflection film and the second working film being coated with a dichroic film;
a lighting optical system, the lighting optical system comprising: a beam shaping component, a wedge-shaped optical component, and a beam guiding component; the wedge-shaped optical component comprising a third working face and a fourth working face which are unparallel to one another, the third working face being coated with a dichroic film, and the fourth working face being coated with a reflective film or a dichroic film;
a DLP light modulator; and
a projection lens group.

2. The DLP pico-projector of claim 1, wherein
the first LED luminous chip, the second LED luminous chip, and the third LED luminous chip emit a first beam, a second beam, and a third beam, respectively; the first beam or the second beam is coincident with a central optical axis of the first collimation lens group, and the third beam is coincident with a central optical axis of the second collimation lens group.

3. The DLP pico-projector of claim 1, wherein
the beam shaping component comprises a fly-eye lens or an optical wand and a first relay lens.

4. The DLP pico-projector of claim 3, wherein
the beam shaping component is disposed between the light supply device and the wedge-shaped optical component, or between the wedge-shaped optical component and the beam guiding component.

5. The DLP pico-projector of claim 1, wherein
a dihedral angle formed by the third working face and the fourth working face is greater than 1 degree and smaller than 45 degrees.

6. The DLP pico-projector of claim 5, wherein
an included angle formed by the wedge-shaped optical component and a central optical axle of the beam shaping component is greater than 15 degrees and smaller than 80 degrees.

7. The DLP pico-projector of claim 6, wherein
the beam guiding component comprises a relay lens and a right-angle prism group.

8. The DLP pico-projector of claim 6, wherein
the beam guiding component comprises a freeform lens and a right-angle prism.

9. The DLP pico-projector of claim 6, wherein
the beam guiding component comprises a field lens and a reflection mirror.

10. The DLP pico-projector of claim 2, wherein
a dihedral angle formed by the third working face and the fourth working face is greater than 1 degree and smaller than 45 degrees.

11. The DLP pico-projector of claim 3, wherein
a dihedral angle formed by the third working face and the fourth working face is greater than 1 degree and smaller than 45 degrees.

12. The DLP pico-projector of claim 4, wherein
a dihedral angle formed by the third working face and the fourth working face is greater than 1 degree and smaller than 45 degrees.
